(19) United States
(12) Patent Application Publication
(10) Pub. No.: US 2016/0041198 A1
(43) Pub. Date: Feb. 11, 2016

(54) PHYSICAL QUANTITY SENSOR, ELECTRONIC DEVICE, AND MOVING OBJECT

(71) Applicant: SEIKO EPSON CORPORATION, Tokyo (JP)

(72) Inventor: Satoru Tanaka, Chino (JP)

(21) Appl. No.: 14/451,889

(22) Filed: Aug. 5, 2014

(51) Int. Cl. G01P 15/125

(52) U.S. Cl. CPC G01P 15/125

(57) ABSTRACT

A physical quantity sensor according to the embodiment includes: a substrate; a first movable body which is disposed on the substrate, can be displaced around a first support shaft, and includes a first movable electrode portion; a second movable body which is disposed on the substrate, can be displaced around a second support shaft, and includes a second movable electrode portion; and a fixed electrode portion which is overlapped on the first movable electrode portion and the second movable electrode portion and is disposed on the substrate in a plan view.

### CROSS-REFERENCE TO RELATED APPLICATIONS

This application claims priority to Japanese Patent Application No. 2013-163001 filed on Aug. 6, 2013. The entire disclosure of Japanese Patent Application No. 2013-163001 is hereby incorporated herein by reference.

### BACKGROUND

1. Technical Field

The present invention relates to a physical quantity sensor, an electronic device, and a moving object.

2. Related Art

In recent years, a physical quantity sensor for detecting a physical quantity such as acceleration has been developed by using silicon micro electro mechanical systems (MEMS), for example.

The physical quantity sensor, for example, includes a substrate, a fixed electrode portion fixed to the substrate, and a movable body including a movable electrode portion disposed to oppose the fixed electrode portion, and detects the physical quantity such as acceleration based on electrostatic capacitance between the movable electrode portion and the fixed electrode portion.

JP-A-2011-247812 discloses a physical quantity sensor for detecting acceleration in a vertical direction (vertical direction is used as a detection direction) including two movable bodies and four fixed electrode portions provided to correspond to movable electrode portions of the movable bodies, in order to remove an error due to sensitivity of detection in a direction other than the detection direction by a signal process.

However, wires connected to each fixed electrode portion are provided in the physical quantity sensor described above in order to apply a potential to four fixed electrode portions. Accordingly, a layout of the wires becomes complicated, and it is difficult to realize miniaturization of the physical quantity sensor, in some cases.

### SUMMARY

An advantage of some aspects of the invention is to provide a physical quantity sensor which can set a layout of wires simply and realize miniaturization. Another advantage of some aspects of the invention is to provide an electronic device and a moving object including the physical quantity sensor described above.

The invention can be implemented as the following forms or application examples.

### Application Example 1

A physical quantity sensor according to this application example includes: a substrate; a first movable body which is disposed on the substrate, can be displaced around a first support shaft, and includes a first movable electrode portion; a second movable body which is disposed on the substrate, can be displaced around a second support shaft, and includes a second movable electrode portion; and a fixed electrode portion which is overlapped on the first movable electrode portion and the second movable electrode portion and is disposed on the substrate in a plan view.

According to the physical quantity sensor of this application example, it is possible to simplify a layout of wires, compared to a case in which the wires are connected to each of four fixed electrode portions (case in which the wires are drawn from each of four fixed electrode portions), for example. As a result, it is possible to realize miniaturization of the physical quantity sensor.

### Application Example 2

In the physical quantity sensor according to the application example described above, when the first movable body is divided into a first portion and a second portion with the first support shaft as a boundary, the physical quantity sensor may further include a first fixed electrode portion which is disposed on the substrate to oppose the first portion, and a second fixed electrode portion which is disposed on the substrate to oppose the second portion, and when the second movable body is divided into a third portion and a fourth portion with the second support shaft as a boundary, the physical quantity sensor may further include a third fixed electrode portion which is disposed on the substrate to oppose the third portion and is electrically connected to the second fixed electrode portion, and a fourth fixed electrode portion which is disposed on the substrate to oppose the fourth portion.

According to the physical quantity sensor of this application example, it is possible to simplify the layout of the wires, compared to a case in which the wires are connected to each of four fixed electrode portions, for example. As a result, it is possible to realize miniaturization of the physical quantity sensor.

In the description according to the invention, a phrase “electrically connected” is used, for example, to describe, “a specific member (hereinafter, referred to as a “B member”) which is “electrically connected” to another specific member (hereinafter, referred to as an “A member”)”. In the description according to the invention, in a case of this example, the phrase “electrically connected” is used in both cases when the A member and the B member directly come in contact with each other and are electrically connected to each other, and when the A member and the B member are electrically connected through another member.

### Application Example 3

In the physical quantity sensor according to the application example described above, the second fixed electrode portion and the third fixed electrode portion may be connected to a first pad by a first wire, and the first fixed electrode portion and the fourth fixed electrode portion may be connected to a second pad by a second wire.

In the physical quantity sensor of this application example, it is possible to simplify the layout of the wires, compared to a case in which the wires are connected to each of four fixed electrode portions, for example. As a result, it is possible to realize miniaturization of the physical quantity sensor.

### Application Example 4

The physical quantity sensor according to the application example described above may further include a signal processing circuit, and the signal processing circuit may calculate a difference between an output signal of the first pad and an output signal of the second pad.

In the physical quantity sensor of this application example, it is possible to detect physical quantity such as a direction or a size of the acceleration, the angular velocity, or the like, by a differential detection system.

### Application Example 5

In the physical quantity sensor according to the application example described above, the first fixed electrode portion, the second fixed electrode portion, the third fixed electrode portion, and the fourth fixed electrode portion may be provided on the same substrate.

In the physical quantity sensor of this application example, it is possible to simplify the layout of the wires to realize miniaturization.

### Application Example 6

In the physical quantity sensor according to the application example described above, an electrode may be disposed in at least one of an area between the first fixed electrode portion and the second fixed electrode portion, an area between the second fixed electrode portion and the third fixed electrode portion, and an area between the third fixed electrode portion and the fourth fixed electrode portion, on the substrate.

In the physical quantity sensor of this application example, it is possible to suppress an electrostatic force acting between the first movable body or the second movable body and the substrate, and to prevent the first movable body or the second movable body from being stuck to the substrate. Therefore, the first movable body or the second movable body is not stuck to the substrate due to the first movable body or the second movable body being pulled to the substrate side by the electrostatic force, due to generation of a difference in potential between the first movable body or the second movable body and the substrate, when manufacturing the physical quantity sensor, for example.

### Application Example 7

In the physical quantity sensor according to the application example described above, the electrode disposed between the first fixed electrode portion and the second fixed electrode portion may be electrically connected to the first movable body.

In the physical quantity sensor of this application example, it is possible to suppress the electrostatic force acting between the first movable body or the second movable body and the substrate, and to prevent the first movable body or the second movable body from being stuck to the substrate.

### Application Example 8

In the physical quantity sensor according to the application example described above, the electrode disposed between the second fixed electrode portion and the third fixed electrode portion may be electrically connected to at least one of the first movable body and the second movable body.

In the physical quantity sensor of this application example, it is possible to suppress the electrostatic force acting between the first movable body or the second movable body and the substrate, and to prevent the first movable body or the second movable body from being stuck to the substrate.

### Application Example 9

In the physical quantity sensor according to the application example described above, the electrode disposed between the third fixed electrode portion and the fourth fixed electrode portion may be electrically connected to the second movable body.

In the physical quantity sensor of this application example, it is possible to suppress the electrostatic force acting between the first movable body or the second movable body and the substrate, and to prevent the first movable body or the second movable body from being stuck to the substrate.

### Application Example 10

In the physical quantity sensor according to the application example described above, the electrodes may be disposed on both sides of the respective first fixed electrode portion, the second fixed electrode portion, the third fixed electrode portion, and the fourth fixed electrode portion.

In the physical quantity sensor of this application example, it is possible to easily set parasitic capacitance generated between the first fixed electrode portion and the electrodes, parasitic capacitance generated between the second fixed electrode portion and the electrodes, parasitic capacitance generated between the third fixed electrode portion and the electrodes, and parasitic capacitance generated between the fourth fixed electrode portion and the electrodes, to be equivalent to each other. Therefore, it is possible to remove an influence of the parasitic capacitance on the first fixed electrode portion, the second fixed electrode portion, the third fixed electrode portion, and the fourth fixed electrode portion, by using the differential detection system.

### Application Example 11

In the physical quantity sensor according to the application example described above, groove portions may be provided on the substrate between the electrodes and the fixed electrode portions adjacent thereto.

In the physical quantity sensor of this application example, it is possible to suppress an electrostatic force acting between the first movable body or the second movable body and the substrate, and to further reliably prevent the first movable body and the second movable body from being stuck to the substrate.

### Application Example 12

An electronic device according to this application example includes the physical quantity sensor according to Application Example 1.

Since the electronic device includes the physical quantity sensor according to the application example described above, it is possible to realize miniaturization.

### Application Example 13

A moving object according to this application example includes the physical quantity sensor according to Application Example 1.

Since the moving object includes the physical quantity sensor according to the application example described above, it is possible to realize miniaturization.

### BRIEF DESCRIPTION OF THE DRAWINGS

The invention will be described with reference to the accompanying drawings, wherein like numbers reference like elements.

FIG. 1 is a plan view schematically showing a physical quantity sensor according to an embodiment.

FIG. 2 is a cross-sectional view schematically showing the physical quantity sensor according to the embodiment.

FIG. 3 is a cross-sectional view schematically showing the physical quantity sensor according to the embodiment.

FIG. 4 is a cross-sectional view schematically showing the physical quantity sensor according to the embodiment.

FIG. 5 is a cross-sectional view schematically showing a manufacturing step of the physical quantity sensor according to the embodiment.

FIG. 6 is a cross-sectional view schematically showing the manufacturing step of the physical quantity sensor according to the embodiment.

FIG. 7 is a cross-sectional view schematically showing the manufacturing step of the physical quantity sensor according to the embodiment.

FIG. 8 is a plan view schematically showing a physical quantity sensor according to First Modification Example of the embodiment.

FIG. 9 is a cross-sectional view schematically showing the physical quantity sensor according to First Modification Example of the embodiment.

FIG. 10 is a plan view schematically showing a physical quantity sensor according to Second Modification Example of the embodiment.

FIG. 11 is a cross-sectional view schematically showing the physical quantity sensor according to Second Modification Example of the embodiment.

FIG. 12 is a plan view schematically showing a physical quantity sensor according to Third Modification Example of the embodiment.

FIG. 13 is a cross-sectional view schematically showing the physical quantity sensor according to Third Modification Example of the embodiment.

FIG. 14 is a perspective view schematically showing an electronic device according to the embodiment.

FIG. 15 is a perspective view schematically showing the electronic device according to the embodiment.

FIG. 16 is a perspective view schematically showing the electronic device according to the embodiment.

FIG. 17 is a perspective view schematically showing a moving object according to the embodiment.

### DESCRIPTION OF EXEMPLARY EMBODIMENTS

Hereinafter, a preferred embodiment of the invention will be described in detail with reference to the drawings. The embodiment which will be described hereinafter does not unduly limit the content of the invention that is claimed. All configurations which will be described hereinafter are not necessarily compulsory constituent elements of the invention.

### 1. Physical Quantity Sensor

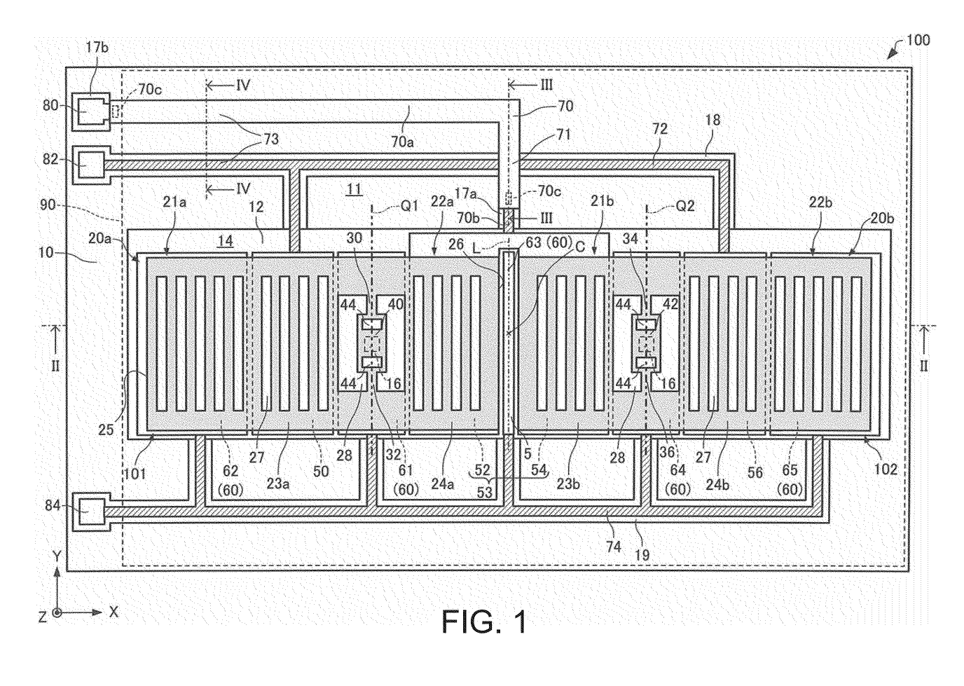

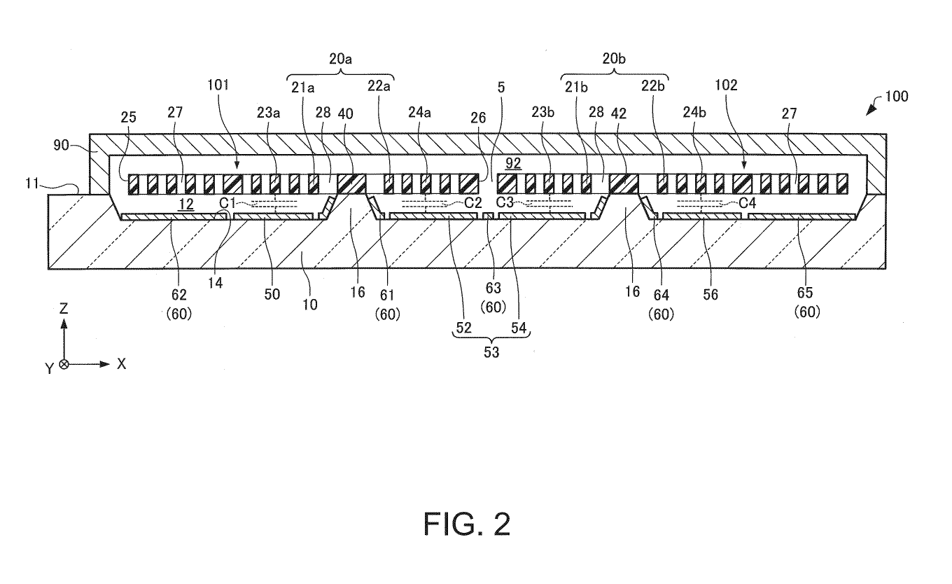

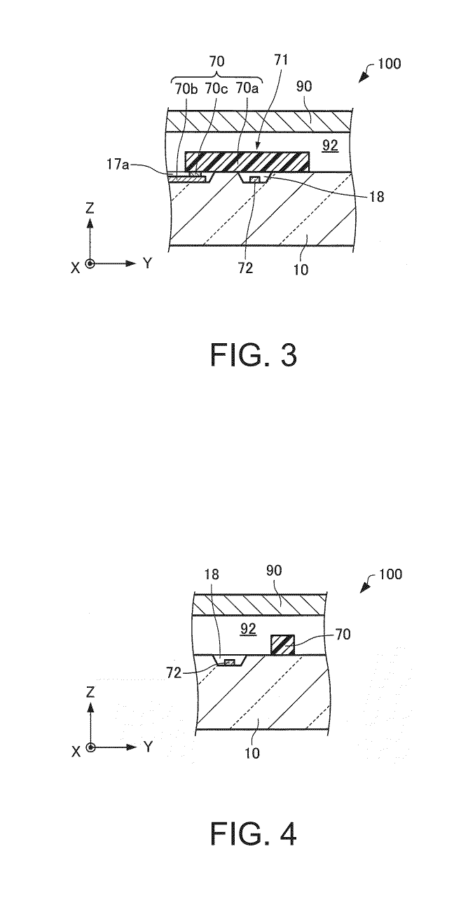

First, a physical quantity sensor according to the embodiment will be described with reference to the drawings. FIG. 1 is a plan view schematically showing a physical quantity sensor 100 according to the embodiment. FIG. 2 is a cross-sectional view taken along line II-II of FIG. 1 and schematically showing the physical quantity sensor 100 according to the embodiment. FIG. 3 is a cross-sectional view taken along line of FIG. 1 and schematically showing the physical quantity sensor 100 according to the embodiment. FIG. 4 is a cross-sectional view taken along line IV-IV of FIG. 1 and schematically showing the physical quantity sensor 100 according to the embodiment. For convenience, a cover 90 is shown to be transparent in FIG. 1. In addition, in FIGS. 1 to 4, an X axis, a Y axis, and Z axis are shown as three axes which are orthogonal with respect to each other.

As shown in FIGS. 1 to 4, the physical quantity sensor 100 includes a substrate 10, movable bodies 20a and 20b, supports 30, 32, 34, and 36, fixed portions 40 and 42, fixed electrode portions 50, 52, 54, and 56, electrodes 60, wires 70, 72, and 74, pads 80, 82, and 84, and the cover 90. Hereinafter, an example in which the physical quantity sensor 100 is an acceleration sensor (capacitance type MEMS acceleration sensor) for detecting acceleration in a vertical direction (Z axis direction) will be described.

A material of the substrate 10 is, for example, an insulating material such as glass or the like. By using the insulating material such as glass for the substrate 10 and using a semiconductor material such as silicon for the movable bodies 20a and 20b, for example, it is possible to easily electrically insulate both components from each other and to simplify a sensor structure.

A recess 12 is formed on a surface 11 of the substrate 10. The movable bodies 20a and 20b and the supports 30, 32, 34, and 36 are provided above the recess 12 with a gap interposed therebetween. In the example shown in FIG. 1, a planar shape (shape when seen from the Z axis direction) of the recess 12 is a rectangular shape.

The substrate 10 includes a post portion 16 provided on a bottom surface (surface of the substrate 10 for regulating the recess 12) 14 of the recess 12. The post portion 16 protrudes to the upper portion (positive Z axis direction) with respect to the bottom surface 14. A height of the post portion 16 and a depth of the recess 12 are, for example, equivalent to each other. Two post portions 16 are provided. The third wire 74 for applying a predetermined potential to the movable bodies 20a and 20b is provided on the post portion 16.

The first movable body 20a, the supports 30 and 32, and the fixed portion 40 are integrally provided. The first movable body 20a, the supports 30 and 32, and the fixed portion 40 configure a first structure 101. A material of the first structure 101 is, for example, silicon to which conductivity is applied by doping with an impurity such as phosphorus or boron.

The first movable body 20a can be displaced around a first support shaft Q1. In detail, when the acceleration is applied in the vertical direction (Z axis direction), the first movable body 20a seesaws using the first support shaft Q1 determined by the supports 30 and 32 as a rotation shaft (rocking shaft). The first support shaft Q1 is parallel with the Y axis, for example. In the example shown in the drawing, a planar shape of the first movable body 20a is a rectangular shape. A thickness (size in the Z axis direction) of the first movable body 20a is constant, for example.

The first movable body 20a includes a first seesaw piece (first portion) 21a and a second seesaw piece (second portion) 22a. The first seesaw piece 21a is one (portion positioned at the left in FIG. 1) of two portions of the first movable body 20a partitioned by the first support shaft Q1 in a plan view. The second seesaw piece 22a is the other one (portion positioned at the right in FIG. 1) of two portions of the first movable body 20a partitioned by the first support shaft Q1 in a plan view. That is, the first movable body 20a is divided into the first seesaw piece 21a and the second seesaw piece 22a with the first support shaft Q1 as a boundary.

When acceleration in the vertical direction (for example, gravity acceleration) is applied to the first movable body 20a, there is a rotation moment (moment of force) for each of the first seesaw piece 21a and the second seesaw piece 22a. Herein, when the rotation moment (for example, counter-clockwise rotation moment) of the first seesaw piece 21a and the rotation moment (for example, clockwise rotation moment) of the second seesaw piece 22a are balanced, the inclination of the first movable body 20a does not change and it is difficult to detect the acceleration. Accordingly, the first movable body 20a is designed so that the rotation moment of the first seesaw piece 21a and the rotation moment of the second seesaw piece 22a are not balanced to have a predetermined inclination of the first movable body 20a, when the acceleration in the vertical direction is applied.

In the physical quantity sensor 100, by disposing the first support shaft Q1 in a position deviated from the center (center of gravity) of the first movable body 20a (by differentiating distances from the first support shaft Q1 to distal ends of the seesaw pieces 21a and 22a), the seesaw pieces 21a and 22a have different masses from each other. That is, one side (first seesaw piece 21a) and the other side (second seesaw piece 22a) of the first movable body 20a have different masses from each other with the first support shaft Q1 as a boundary. In the example shown in the drawing, a distance from the first support shaft Q1 to an end surface 25 of the first seesaw piece 21a is greater than a distance from the first support shaft Q1 to an end surface 26 of the second seesaw piece 22a. A thickness of the first seesaw piece 21a and a thickness of the second seesaw piece 22a are equivalent to each other. Accordingly, the mass of the first seesaw piece 21a is greater than the mass of the second seesaw piece 22a. As described above, the seesaw pieces 21a and 22a have different masses from each other, and therefore when the acceleration in the vertical direction is applied, it is possible to have the rotation moment of the first seesaw piece 21a and the rotation moment of the second seesaw piece 22a not be balanced. Accordingly, when the acceleration in the vertical direction is applied, it is possible to have a predetermined inclination of the first movable body 20a.

Although not shown, the seesaw pieces 21a and 22a may have different masses from each other by disposing the first support shaft Q1 at the center of the first movable body 20a and setting the thicknesses of the seesaw pieces 21a and 22a different from each other. Even in this case, when the acceleration in the vertical direction is applied, it is possible to have a predetermined inclination of the first movable body 20a.

The first movable body 20a is provided to be separated from the substrate 10. The first movable body 20a is provided above the recess 12. In the example shown in the drawing, a gap is provided between the first movable body 20a and the substrate 10. In addition, the first movable body 20a is provided to be separated from the fixed portion 40 by the supports 30 and 32. Accordingly, the first movable body 20a can be seesawed.

The first movable body 20a includes a third movable electrode portion 23a and a first movable electrode portion 24a which are provided with the first support shaft Q1 as a boundary. The third movable electrode portion 23a is provided on the first seesaw piece 21a. The first movable electrode portion 24a is provided on the second seesaw piece 22a.

The third movable electrode portion 23a is a portion overlapping the first fixed electrode portion 50 on the first movable body 20a, in a plan view. The third movable electrode portion 23a forms capacitance C1 between the third movable electrode portion and the first fixed electrode portion 50. That is, the capacitance C1 is formed by the third movable electrode portion 23a and the first fixed electrode portion 50.

The first movable electrode portion 24a is a portion overlapping the second fixed electrode portion 52 on the first movable body 20a, in a plan view. The first movable electrode portion 24a forms capacitance C2 between the first movable electrode portion and the second fixed electrode portion 52. That is, the capacitance C2 is formed by the first movable electrode portion 24a and the second fixed electrode portion 52. In the physical quantity sensor 100, by configuring the first movable body 20a with a conductive material (silicon to which an impurity is doped), the movable electrode portions 23a and 24a are provided. That is, the first seesaw piece 21a functions as the third movable electrode portion 23a and the second seesaw piece 22a functions as the first movable electrode portion 24a.

The capacitance C1 and capacitance C2 are configured so as to be equivalent to each other in a horizontal state of the first movable body 20a shown in FIG. 2, for example. The movable electrode portions 23a and 24a change the positions thereof according to the movement of the first movable body 20a. The capacitances C1 and C2 change according to the positions of the movable electrode portions 23a and 24a. A predetermined potential is applied to the first movable body 20a through the supports 30 and 32.

A slit portion 27 which penetrates through the first movable body 20a is formed on the first movable body 20a. Accordingly, it is possible to reduce an influence of air (resistance of air) when swinging the first movable body 20a. A plurality of the slit portions 27 are provided, for example. In the example shown in the drawing, a planar shape of the slit portion 27 is a rectangular shape.

An opening portion 28 which penetrates through the first movable body 20a is formed on the first movable body 20a. The supports 30 and 32 and the fixed portion 40 are provided on the opening portion 28. In the example shown in the drawing, a planar shape of the opening portion 28 is a rectangular shape. The first movable body 20a is connected to the fixed portion 40 through the supports 30 and 32.

The supports 30 and 32 support the first movable body 20a so as to be displaced around the first support shaft Q1. The supports 30 and 32 function as torsion springs (twist springs). Accordingly, the supports 30 and 32 may have a strong restoring force with respect to torsional deformation generated on the supports 30 and 32 due to seesawing of the first movable body 20a.

The supports 30 and 32 are disposed on the first support shaft Q1 in a plan view. The supports 30 and 32 are extended along the first support shaft Q1. The support 30 is extended in a positive Y axis direction from the fixed portion 40. The support 32 is extended in a negative Y axis direction from the fixed portion 40.

The fixed portion 40 is provided on the opening portion 28. The fixed portion 40 is provided on the first support shaft Q1 in a plan view. The fixed portion 40 is bonded to the post portion 16 of the substrate 10. In a case where the material of the fixed portion 40 (of the first structure 101) is silicon and the material of the substrate 10 is glass, the fixed portion 40 and the substrate 10 are bonded to each other by anode bonding, for example. In the example shown in the drawing, the center portion of the fixed portion 40 is bonded to the substrate 10.

A penetration hole 44 is formed on a portion of the fixed portion 40 separated from the substrate 10. The penetration hole 44 is disposed on the first support shaft Q1 in a plan view. By forming the penetration hole 44 on the fixed portion 40, it is possible to reduce an influence of stress generated due to a difference between a coefficient of thermal expansion of the substrate 10 and a coefficient of thermal expansion of the first structure 101, stress applied to a device when mounting the device, or the like, on the supports 30 and 32.

In the physical quantity sensor 100, the first structure 101 is fixed to the substrate 10 by one fixed portion 40. That is, the first structure 101 is fixed to the substrate 10 at one point (one fixed portion 40). Accordingly, it is possible to reduce the influence of stress generated due to a difference between a coefficient of thermal expansion of the substrate 10 and a coefficient of thermal expansion of the first structure 101, stress applied to a device when mounting the device, or the like, on the supports 30 and 32, compared to a case where the structure is fixed to the substrate at two points (two fixed portions), for example.

Although not shown, the fixed portion 40 may be provided on a portion of the surface 11 positioned in the positive Y axis direction of the first movable body 20a and a position thereof in the negative Y axis direction of the first movable body 20a. In this case, the opening portion 28 may not be formed on the first movable body 20a.

The second movable body 20b, the supports 34 and 36, and the fixed portion 42 are integrally provided. The second movable body 20b, the supports 34 and 36, and the fixed portion 42 configure a second structure 102. A material of the second structure 102 is the same as the material of the first structure 101.

The second movable body 20b includes a third seesaw piece (third portion) 21b and a fourth seesaw piece (fourth portion) 22b. The third seesaw piece 21b is one (portion positioned at the left in FIG. 1) of two portions of the second movable body 20b partitioned by a second support shaft Q2 in a plan view. The fourth seesaw piece 22b is the other one (portion positioned at the right in FIG. 1) of two portions of the second movable body 20b partitioned by the second support shaft Q2 in a plan view. That is, the second movable body 20b is divided into the third seesaw piece 21b and the fourth seesaw piece 22b with the second support shaft Q2 as a boundary.

The second movable body 20b can be displaced around the second support shaft Q2. The second movable body 20b includes a second movable electrode portion 23b and a fourth movable electrode portion 24b which are provided with the second support shaft Q2 as a boundary. The second movable electrode portion 23b is provided on the third seesaw piece 21b. The second movable electrode portion 23b is a portion overlapping the third fixed electrode portion 54 on the second movable body 20b, in a plan view. The second movable electrode portion 23b forms capacitance C3 between the second movable electrode portion and the third fixed electrode portion 54. The fourth movable electrode portion 24b is provided on the fourth seesaw piece 22b. The fourth movable electrode portion 24b is a portion overlapping the fourth fixed electrode portion 56 on the second movable body 20b, in a plan view. The fourth movable electrode portion 24b forms capacitance C4 between the fourth movable electrode portion and the fourth fixed electrode portion 56.

The second structure 102 configured with the second movable body 20b, the supports 34 and 36, and the fixed portion 42 and the first structure 101 configured with the first movable body 20a, the supports 30 and 32, and the fixed portion 40 are, for example, disposed to be symmetrical about a virtual straight line (straight line which passes through a center C of the recess 12 and is parallel with the Y axis in a plan view) L. The description of the members configuring the first structure 101 described above can be applied to the description of the members configuring the second structure 102. In the example shown in FIG. 1, the movable electrode portions 23a, 23b, 24a, and 24b are arranged in the X axis direction in the order of the third movable electrode portion 23a, the first movable electrode portion 24a, the second movable electrode portion 23b, and the fourth movable electrode portion 24b.

The first fixed electrode portion 50 is provided on the substrate 10. The first fixed electrode portion 50 is disposed to oppose the third movable electrode portion 23a. The third movable electrode portion 23a is positioned above the first fixed electrode portion 50 with a gap interposed therebetween. When the first movable body 20a is divided into the first seesaw piece 21a and the second seesaw piece 22a with the first support shaft Q1 as a boundary, the first fixed electrode portion 50 is disposed on the substrate 10 to oppose the first seesaw piece 21a.

The second fixed electrode portion 52 is provided on the substrate 10. The second fixed electrode portion 52 is disposed to oppose the first movable electrode portion 24a. The first movable electrode portion 24a is positioned above the second fixed electrode portion 52 with a gap interposed therebetween. When the first movable body 20a is divided into the first seesaw piece 21a and the second seesaw piece 22a with the first support shaft Q1 as a boundary, the second fixed electrode portion 52 is disposed on the substrate 10 to oppose the second seesaw piece 22a.

The third fixed electrode portion 54 is provided on the substrate 10. The third fixed electrode portion 54 is disposed to oppose the second movable electrode portion 23b. The second movable electrode portion 23b is positioned above the third fixed electrode portion 54 with a gap interposed therebetween. When the second movable body 20b is divided into the third seesaw piece 21b and the fourth seesaw piece 22b with the second support shaft Q2 as a boundary, the third fixed electrode portion 54 is disposed on the substrate 10 to oppose the third seesaw piece 21b.

The third fixed electrode portion 54 forms a common electrode 53 with the second fixed electrode portion 52. The third fixed electrode portion 54 is electrically connected to the second fixed electrode portion 52. The third fixed electrode portion 54 is integrally provided with the second fixed electrode portion 52. The common electrode 53 is overlapped on the movable electrode portions 23b and 24a and disposed on the substrate 10 in a plan view. A third electrode 63 is provided between the fixed electrode portions 52 and 54. In the example shown in the drawing, a cut-out portion 5 is provided in an area of the common electrode 53 between the fixed electrode portions 52 and 54, and the third electrode 63 is provided on the cut-out portion 5.

The fourth fixed electrode portion 56 is provided on the substrate 10. The fourth fixed electrode portion 56 is disposed to oppose the fourth movable electrode portion 24b. The fourth movable electrode portion 24b is positioned above the fourth fixed electrode portion 56 with a gap interposed therebetween. When the second movable body 20b is divided into the third seesaw piece 21b and the fourth seesaw piece 22b with the second support shaft Q2 as a boundary, the fourth fixed electrode portion 56 is disposed on the substrate 10 to oppose the fourth seesaw piece 22b. The fixed electrode portions 50, 52, 54, and 56 are provided on the same substrate 10.

The first fixed electrode portion 50 is provided between electrodes 61 and 62. The second fixed electrode portion 52 is provided between electrodes 61 and 63. The third fixed electrode portion 54 is provided between electrodes 63 and 64. The fourth fixed electrode portion 56 is provided between electrodes 64 and 65. That is, the electrodes 60 are disposed on both sides of respective fixed electrode portions 50, 52, 54, and 56. The number of electrodes 60 adjacent to respective fixed electrode portions 50, 52, 54, and 56 is two. As described above, in the physical quantity sensor 100, the number of electrodes 60 adjacent to the first fixed electrode portion 50, the number of electrodes 60 adjacent to the second fixed electrode portion 52, the number of electrodes 60 adjacent to the third fixed electrode portion 54, and the number of electrodes 60 adjacent to the fourth fixed electrode portion 56 are equivalent to each other.

An area of the first fixed electrode portion 50 of the portion opposing the first movable body 20a, an area of the second fixed electrode portion 52 of the portion opposing the first movable body 20a, an area of the third fixed electrode portion 54 of the portion opposing the second movable body 20b, an area of the fourth fixed electrode portion 56 of the portion opposing the second movable body 20b are equivalent to each other, for example.

Although not shown, the first fixed electrode portion 50 is provided in a position of the cover 90 opposing the third movable electrode portion 23a, the second fixed electrode portion 52 is provided in a position of the cover 90 opposing the first movable electrode portion 24a, the third fixed electrode portion 54 is provided in a position of the cover 90 opposing the second movable electrode portion 23b, and the fourth fixed electrode portion 56 is provided in a position of the cover 90 opposing the fourth movable electrode portion 24b.

The electrodes 60 are provided on the substrate 10. In the example shown in the drawing, the electrodes 60 are provided on the bottom surface 14 of the recess 12. The plurality of electrodes 60 are provided. The electrodes 60 are electrically connected to the movable bodies 20a and 20b. Accordingly, in the physical quantity sensor 100, it is possible to make the electrodes 60 and the movable bodies 20a and 20b to be equipotential. Therefore, the electrodes 60 can suppress an electrostatic force acting between the structures 101 and 102 (movable bodies 20a and 20b) and the substrate 10.

The first electrode 61 among the plurality of electrodes 60 is provided in an area between the first fixed electrode portion 50 and the second fixed electrode portion 52 of the substrate 10. The first electrode 61 is provided to oppose the first movable body 20a and the supports 30 and 32. That is, the first electrode 61 is overlapped with the first movable body 20a and the supports 30 and 32 in a plan view. The first movable body 20a and the supports 30 and 32 are positioned above the first electrode 61 with a gap interposed therebetween. A part of the first electrode 61 is provided on the surface of the post portion 16 and is connected to the fixed portion 40.

The second electrode 62 among the plurality of electrodes 60 is provided in an area of the substrate 10 overlapped with the first seesaw piece 21a in a plan view and in an area in the negative X axis direction of the first fixed electrode portion 50. The second electrode 62 is disposed to oppose the first seesaw piece 21a. The first seesaw piece 21a is positioned above the second electrode 62 with a gap interposed therebetween.

The third electrode 63 among the plurality of electrodes 60 is provided in an area between the second fixed electrode portion 52 and the third fixed electrode portion 54 of the substrate 10. The third electrode 63 is disposed in a position not overlapped with the movable bodies 20a and 20b in a plan view, for example.

The fourth electrode 64 among the plurality of electrodes 60 is provided in an area between the third fixed electrode portion 54 and the fourth fixed electrode portion 56 of the substrate 10. The fourth electrode 64 is provided to oppose the second movable body 20b and the supports 34 and 36. That is, the fourth electrode 64 is overlapped with the second movable body 20b and the supports 34 and 36 in a plan view. The second movable body 20b and the supports 34 and 36 are positioned above the fourth electrode 64 with a gap interposed therebetween. A part of the fourth electrode 64 is provided on the surface of the post portion 16 and is connected to the fixed portion 42.

The fifth electrode 65 among the plurality of electrodes 60 is provided in an area of the substrate 10 overlapped with the fourth seesaw piece 22b in a plan view and in an area in the positive X axis direction of the fourth fixed electrode portion 56. The fifth electrode 65 is disposed to oppose the fourth seesaw piece 22b. The fourth seesaw piece 22b is positioned above the fifth electrode 65 with a gap interposed therebetween.

The material of the fixed electrode portions 50 and 56, the common electrodes 53, and the electrodes 60 (hereinafter, also referred to as the “fixed electrode portion 50 and the like”) is, for example, aluminum, gold, indium tin oxide (ITO), or the like. The material of the fixed electrode portion 50 and the like is desirably a transparent electrode material such as ITO. This is because a foreign material or the like existing on the fixed electrode portion 50 and the like can be easily visually recognized, by using the transparent electrode material as the material of the fixed electrode portion 50 and the like, in a case where the substrate 10 is a transparent substrate (glass substrate).

The first wire 70 is provided on the substrate 10. The first wire 70 connects the first pad 80 and the common electrode 53 provided on the substrate 10 to each other. That is, the fixed electrode portions 52 and 54 are connected to the first pad 80 by the first wire 70. The first wire 70 includes a silicon portion 70a formed of a silicon layer to which conductivity is applied by doping with an impurity such as phosphorus or boron, a metal portion 70b formed of a metal layer, and contact portions 70c which connect the silicon portion 70a and the metal portion 70b.

The silicon portion 70a of the first wire 70 is provided on the surface 11 of the substrate 10. The silicon portion 70a is bonded to the substrate 10. The metal portion 70b is provided on a bottom surface of a groove portion 17a and the bottom surface 14 of the recess 12 which are formed on the surface 11. In the example shown in the drawing, the silicon portion 70a is connected to the first pad 80 and the metal portion 70b through the contact portions 70c. The metal portion 70b is connected to the common electrode 53. The material of the metal portion 70b is, for example, aluminum, gold, indium tin oxide (ITO), or the like. The material of the contact portions 70c is, for example, aluminum, gold, or platinum.

The second wire 72 is provided on the substrate 10. In detail, the second wire 72 is provided on a bottom surface of a groove portion 18 and the bottom surface 14 of the recess 12 which are formed on the surface 11 of the substrate 10. The second wire 72 connects the second pad 82 and the fixed electrode portions 50 and 56 provided on the substrate 10 to each other. That is, the fixed electrode portions 50 and 56 are connected to the second pad 82 by the second wire 72. The second wire 72 is extended and branched from the second pad 82 and is connected to the fixed electrode portions 50 and 56. The second wire 72 is formed of a metal layer, for example, and in more detail, the material of the second wire 72 is the same as the material of the metal portion 70b of the first wire 70.

The wires 70 and 72 intersect each other in an intersecting portion 71 in a plan view. In the intersecting portion 71, one of the wires 70 and 72 is a silicon layer provided on the substrate 10, and the other one of the wires 70 and 72 is a metal layer provided on a groove portion formed on the substrate 10. In the example shown in the drawing, in the intersecting portion 71, the first wire 70 is the silicon portion 70a (silicon layer) provided on the substrate 10, and the second wire 72 is the metal layer provided on the groove portion 18 formed on the substrate 10.

Although not shown, in the intersecting portion 71, the first wire 70 may be the metal layer provided on the groove portion formed on the substrate 10 and the second wire 72 may be the silicon layer provided on the substrate 10. In addition, although not shown, both the wires 70 and 72 may be the metal layer provided on the groove portion and by providing an insulating layer between the wires 70 and 72 in the intersecting portion 71, the wires 70 and 72 may be separated from each other.

The wires 70 and 72 include parallel running portions 73 which run parallel with each other. In the parallel running portions 73, one of the wires 70 and 72 is the silicon layer provided on the substrate 10 and the other one of the wires 70 and 72 is the metal layer provided on the groove portion formed on the substrate 10. In the example shown in the drawing, in the parallel running portions 73, the first wire 70 is the silicon portion 70a (silicon layer) provided on the substrate 10, and the second wire 72 is the metal layer provided on the groove portion 18 formed on the substrate 10. Herein, the “parallel running portions 73 which run parallel with each other” are the portions where the movable bodies 20a and 20b and the other wires do not exist between the wires 70 and 72, and are the portions extended in parallel with the wires 70 and 72. In the example shown in the drawing, the parallel running portions 73 are the portions extended in the X axis direction of the first wire 70 and the portions extended in the X axis direction of the second wire 72.

Although not shown, in the parallel running portions 73, the first wire 70 may be the metal layer provided on the groove portion formed on the substrate 10, and the second wire 72 may be the silicon layer provided on the substrate 10.

The third wire 74 is provided on the substrate 10. In detail, the third wire 74 is provided on a bottom surface of a groove portion 19 and the bottom surface 14 of the recess 12 formed on the surface 11 of the substrate 10. The third wire 74 connects the third pad 84 and the electrode 60 provided on the substrate 10 to each other. That is, the electrode 60 is connected to the third pad 84 by the third wire 74. The third wire 74 is extended and branched from the third pad 84 and is connected to the electrode 60. The material of the third wire 74 is formed of a metal layer, for example, and in more detail, the material of the third wire 74 is the same as the material of the metal portion 70b of the first wire 70. A part of the third wire 74 may be configured with a silicon layer.

The pads 80, 82, and 84 are provided on the substrate 10. In the example shown in the drawing, the pads 80, 82, and 84 are provided on the groove portions 17b, 18, and 19, respectively, and are connected to the wires 70, 72, and 74. The pads 80, 82, and 84 are provided in a position not overlapped with the cover 90 in a plan view. The material of the pads 80, 82, and 84 is the same as that of the fixed electrode portion 50 and the like, for example.

The cover 90 is provided on (the surface 11 of) the substrate 10. The cover 90 is bonded to the substrate 10. The cover 90 and the substrate 10 form a cavity 92 for accommodating the movable bodies 20a and 20b. The cavity 92 is under an inert gas (for example, nitrogen gas) atmosphere, for example. The material of the cover 90 is silicon, for example. When the material of the cover 90 is silicon and the material of the substrate 10 is glass, the substrate 10 and the cover 90 are bonded to each other by anode bonding, for example.

Next, an operation of the physical quantity sensor 100 will be described.

In the physical quantity sensor 100, the first movable body 20a swings around the first support shaft Q1 and the second movable body 20b swings around the second support shaft Q2, according to the physical quantity such as acceleration or angular velocity. A distance between the third movable electrode portion 23a and the first fixed electrode portion 50 and a distance between the first movable electrode portion 24a and the second fixed electrode portion 52 are changed according to the movement of the first movable body 20a. A distance between the second movable electrode portion 23b and the third fixed electrode portion 54 and a distance between the fourth movable electrode portion 24b and the fourth fixed electrode portion 56 are changed according to the movement of the second movable body 20b.

In detail, when the acceleration vertically upward (positive Z axis direction) is applied to the physical quantity sensor 100, the first movable body 20a rotates counterclockwise, a distance between the third movable electrode portion 23a and the first fixed electrode portion 50 decreases, and a distance between the first movable electrode portion 24a and the second fixed electrode portion 52 increases. As a result, the capacitance C1 increases and the capacitance C2 decreases. In addition, the second movable body 20b rotates clockwise, the distance between the second movable electrode portion 23b and the third fixed electrode portion 54 increases, and the distance between the fourth movable electrode portion 24b and the fourth fixed electrode portion 56 decreases. As a result, the capacitance C3 decreases and the capacitance C4 increases.

When the acceleration vertically downward (negative Z axis direction) is applied to the physical quantity sensor 100, for example, the first movable body 20a rotates clockwise, the distance between third movable electrode portion 23a and the first fixed electrode portion 50 increases, and the distance between the first movable electrode portion 24a and the second fixed electrode portion 52 decreases. As a result, the capacitance C1 decreases and the capacitance C2 increases. In addition, the second movable body 20b rotates counterclockwise, the distance between the second movable electrode portion 23b and the third fixed electrode portion 54 decreases, and the distance between the fourth movable electrode portion 24b and the fourth fixed electrode portion 56 increases. As a result, the capacitance C3 increases and the capacitance C4 decreases.

In the physical quantity sensor 100, a total C2+C3 of the capacitance C2 and the capacitance C3 is detected using the pads 80 and 84, and a total C1+C4 of the capacitance C1 and the capacitance C4 is detected using the pads 82 and 84. It is possible to detect a physical quantity such as a direction or a size of the acceleration, the angular velocity, or the like, based on the difference between C2+C3 and C1+C4 (so-called differential detection system). In detail, the physical quantity sensor 100 includes a signal processing circuit (not shown), and the signal processing circuit can calculate a difference between an output signal of the first pad 80 and an output signal of the second pad 82, to detect a physical quantity such as a direction or a size of the acceleration, the angular velocity, or the like by the differential detection system.

As described above, the physical quantity sensor 100 can be used as an inertial sensor such as an acceleration sensor or a gyro sensor. In detail, the physical quantity sensor 100 can be used as a capacitance type acceleration sensor for measuring the acceleration in the vertical direction (Z axis direction). By including the structures 101 and 102, the physical quantity sensor 100 can remove an error due to sensitivity of detection in a direction (for example, X axis direction) other than the detection direction (Z axis direction), by a signal process. As a result, it is possible to further improve the sensitivity of detection in the Z axis direction.

The physical quantity sensor 100 has the following properties, for example.

The physical quantity sensor 100 includes the substrate 10, the first movable body 20a which is disposed on the substrate 10, can be displaced around the first support shaft Q1, and includes the first movable electrode portion 24a, the second movable body 20b which is disposed on the substrate 10, can be displaced around the second support shaft Q2, and includes the second movable electrode portion 23b, and the fixed electrode portion (common electrode) 53 which is overlapped on the first movable electrode portion 24a and the second movable electrode portion 23b and disposed on the substrate 10 in a plan view.

In detail, the physical quantity sensor 100 includes the first fixed electrode portion 50 which is disposed on the substrate 10 to oppose the first seesaw piece 21a and the second fixed electrode portion 52 which is disposed on the substrate 10 to oppose the second seesaw piece 22a, when the first movable body 20a is divided into the first seesaw piece (first portion) 21a and the second seesaw piece (second portion) 22a with the first support shaft Q1 as a boundary, and includes the third fixed electrode portion 54 which is disposed on the substrate 10 to oppose the third seesaw piece 21b and is electrically connected to the second fixed electrode portion 52 and the fourth fixed electrode portion 56 which is disposed on the substrate 10 to oppose the fourth seesaw piece 22b, when the second movable body 20b is divided into the third seesaw piece (third portion) 21b and the fourth seesaw piece (fourth portion) 22b with the second support shaft Q2 as a boundary.

In the physical quantity sensor 100, the fixed electrode portions 52 and 54 are connected to the first pad 80 by the first wire 70, and the fixed electrode portions 50 and 56 are connected to the second pad 82 by the second wire 72. That is, the fixed electrode portions 52 and 54 configure the common electrode 53, the first wire 70 connects the first pad 80 and the common electrode 53 to each other, and the second wire 72 connects the second pad 82 and the fixed electrode portions 50 and 56 to each other. Accordingly, in the physical quantity sensor 100, a layout of wires can be simplified, compared to a case in which the wires are connected to each of four fixed electrode portions (case in which the wires are drawn from each of four fixed electrode portions), for example. As a result, it is possible to realize miniaturization of the physical quantity sensor 100.

The physical quantity sensor 100 includes the signal processing circuit, and the signal processing circuit calculates the difference between the output signal of the first pad 80 and the output signal of the second pad 82. Accordingly, the physical quantity sensor 100 can remove the error due to sensitivity of detection in a direction (for example, X axis direction) other than the detection direction (Z axis direction), by the signal process. As a result, it is possible to further improve the sensitivity of detection in the Z axis direction.

In the physical quantity sensor 100, the electrode 60 is disposed in at least one of the area between the first fixed electrode portion 50 and the second fixed electrode portion 52, the area between the second fixed electrode portion 52 and the third fixed electrode portion 54, and the area between the third fixed electrode portion 54 and the fourth fixed electrode portion 56, on the substrate 10. The electrode 60 disposed between the fixed electrode portions 50 and 52 is electrically connected to the first movable body 20a. The electrode 60 disposed between the fixed electrode portions 52 and 54 is electrically connected to at least one of the first movable body 20a and the second movable body 20b. The electrode 60 disposed between the fixed electrode portions 54 and 56 is electrically connected to the second movable body 20b. Accordingly, in the physical quantity sensor 100, it is possible to suppress the electrostatic force acting between the movable bodies 20a and 20b and the supports 30, 32, 34, and 36, and the substrate 10 and to prevent the movable bodies 20a and 20b from being stuck to the substrate 10. Therefore, the movable bodies 20a and 20b are not stuck to the substrate 10 due to the movable bodies 20a and 20b and the supports 30, 32, 34, and 36 being pulled to the substrate 10 side by the electrostatic force, due to generation of a difference in potential between the movable bodies 20a and 20b and the supports 30, 32, 34, and 36, and the substrate 10, when manufacturing the physical quantity sensor 100, for example.

In the physical quantity sensor 100, the electrodes 60 are disposed on both sides of respective fixed electrode portions 50, 52, 54, and 56. That is, the number of electrodes 60 adjacent to the first fixed electrode portion 50, the number of electrodes 60 adjacent to the second fixed electrode portion 52, the number of electrodes 60 adjacent to the third fixed electrode portion 54, and the number of electrodes 60 adjacent to the fourth fixed electrode portion 56 are equivalent to each other. Parasitic capacitance generated between the first fixed electrode portion 50 and the electrodes 60, parasitic capacitance generated between the second fixed electrode portion 52 and the electrodes 60, parasitic capacitance generated between the third fixed electrode portion 54 and the electrodes 60, and parasitic capacitance generated between the fourth fixed electrode portion 56 and the electrodes 60 can be easily set to be equivalent to each other. Accordingly, it is possible to reduce an influence of the parasitic capacitance on the fixed electrode portions 50, 52, 54, and 56, by using the differential detection system.

In the physical quantity sensor 100, in the intersecting portions 71 of the wires 70 and 72 which intersect each other, one of the wires 70 and 72 is the silicon layer provided on the substrate 10 and the other one of the wires 70 and 72 is the metal layer provided on the groove portion formed on the substrate 10. Therefore, in the physical quantity sensor 100, it is possible to prevent short circuit of the first wire 70 and the second wire 72. In addition, in the intersecting portions 71, it is not necessary to form an insulating layer between the wires 70 and 72, and it is possible to simplify the manufacturing step.

In the physical quantity sensor 100, in the parallel running portions 73 of the wires 70 and 72, one of the wires 70 and 72 is provided on the substrate 10 and the other one of the wires 70 and 72 is the metal layer provided on the groove portion formed on the substrate 10. Accordingly, in the physical quantity sensor 100, parasitic capacitance of the parallel running portions 73 between the wires 70 and 72 can be decreased. For example, when both the wires in the parallel running portions are the silicon layers formed on the substrate or the metal layers provided on the groove portion, the parasitic capacitance between both the wires increases.

### 1.2. Manufacturing Method of Physical Quantity Sensor

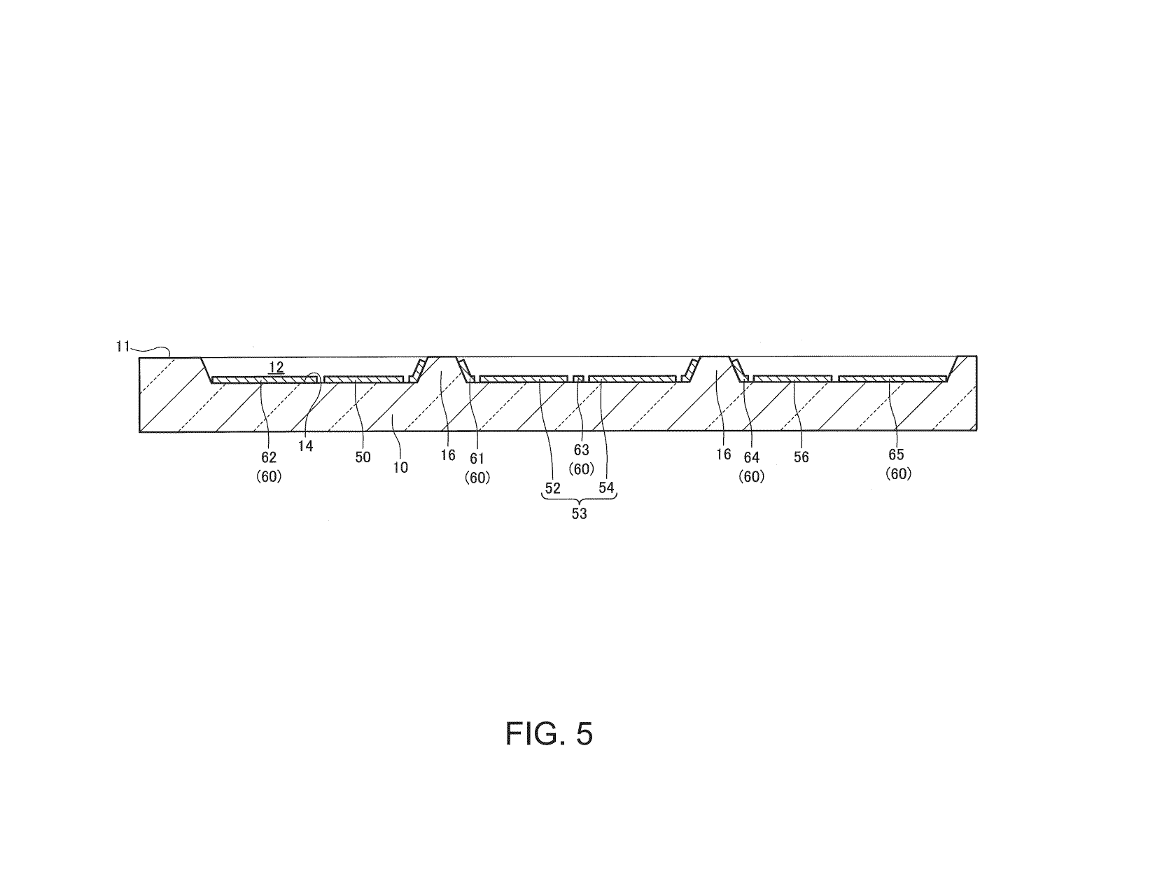

Next, a manufacturing method of the physical quantity sensor according to the embodiment will be described with reference to the drawings. FIG. 5 to FIG. 7 are cross-sectional views schematically showing manufacturing steps of the physical quantity sensor 100 according to the embodiment, and each drawing corresponds to FIG. 2.

As shown in FIG. 5, for example, a glass substrate is patterned to form the substrate 10 on which the recess 12, the post portion 16, and the groove portions 17a, 17b, 18, and 19 are formed. The patterning of the glass substrate is performed by photolithography and etching, for example.

Next, the fixed electrode portions 50 and 56, the common electrode 53, and the electrodes 60 are formed on the bottom surface 14 of the recess 12. The fixed electrode portions 50 and 56, the common electrode 53, and the electrodes 60 are formed by forming a conductive layer on the bottom surface 14 by a sputtering method or the like, and patterning the conductive layer by photolithography and etching. In this step, the fixed electrode portions 52 and 54 are integrally formed as the common electrode 53.

Next, the metal portion 70b and the wires 72 and 74 are formed on the groove portions 17a, 18, and 19. Then, the pads 80, 82, and 84 are formed on the groove portions 17b, 18, and 19. The contact portion 70c is formed on the metal portion 70b and the first pad 80. The metal portion 70b, the contact portion 70c, the wires 72 and 74, and the pads 80, 82, and 84 are formed by forming a conductive layer by the sputtering method or the like and patterning the conductive layer by photolithography and etching.

The step of forming the fixed electrode portions 50 and 56, the common electrode 53, and the electrodes 60, the step of forming the metal portion 70b and the wires 72 and 74, and the step of forming the pads 80, 82, and 84 may be performed in any order.

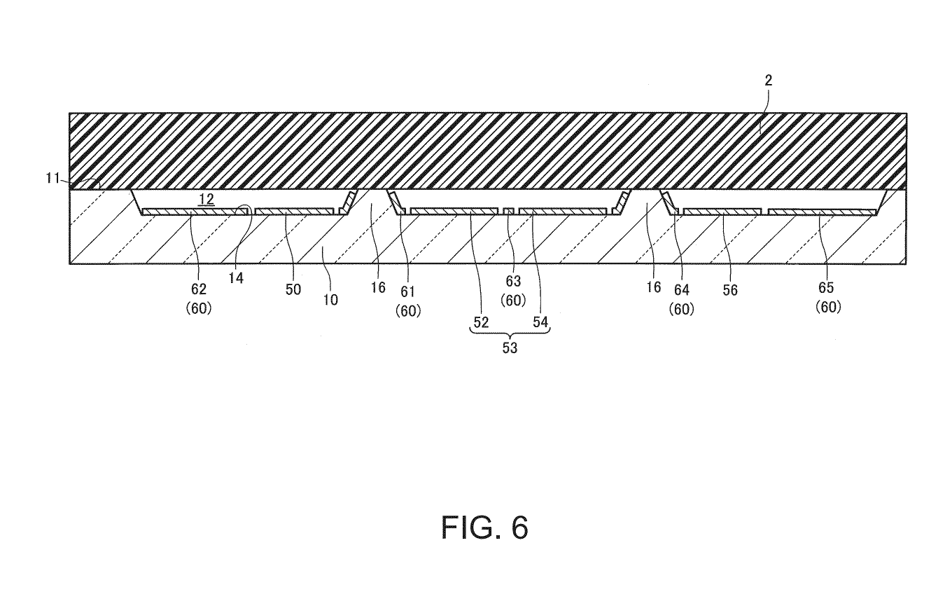

As shown in FIG. 6, a silicon substrate 2 is bonded to the substrate 10. The bonding of the silicon substrate 2 to the substrate 10 is performed by anode bonding.

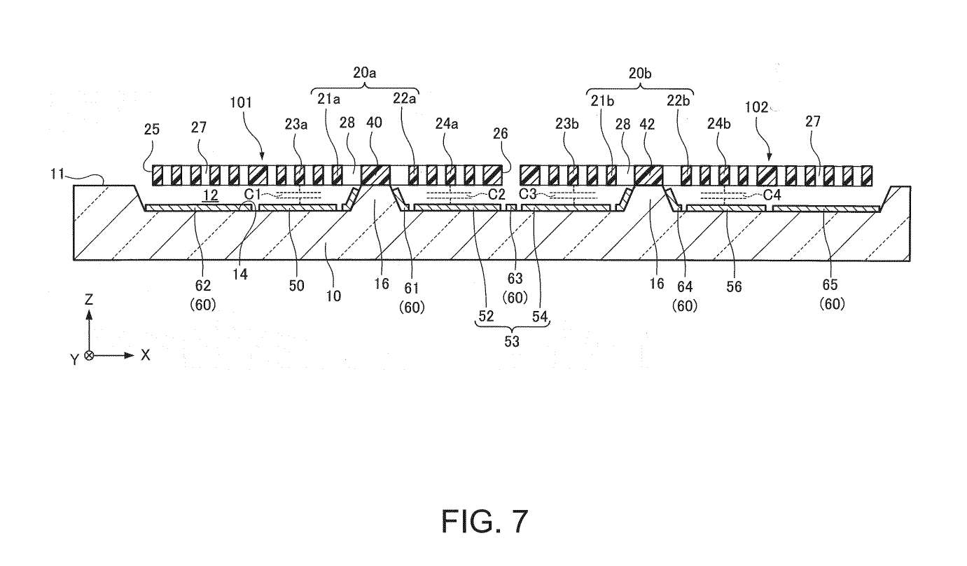

As shown in FIG. 7, the silicon substrate 2 is ground to manufacture a thin film for patterning by a grinding machine, for example, and accordingly the first movable body 20a, the supports 30 and 32, and the fixed portion 40 are integrally formed, and the second movable body 20b, the supports 34 and 36, and the fixed portion 42 are integrally formed. In addition, the silicon portion 70a is formed in the step. Accordingly, the first wire 70 can be formed. The patterning is performed by photolithography and etching (dry etching), and a Bosch method can be used as a more specific etching technology.

As shown in FIG. 2, the cover 90 is bonded to the substrate 10, and the movable bodies 20a and 20b are accommodated in the cavity 92 formed by the substrate 10 and the cover 90. The bonding of the cover 90 to the substrate 10 is performed by anode bonding, for example. This step is performed in the inert gas atmosphere so as to fill the inert gas in the cavity 92.

In the step, a great difference in potential is generated between the first structure 101 and the substrate 10 and between the second structure 102 and the substrate 10, when bonding the cover 90 to the substrate 10. However, in the physical quantity sensor 100, it is possible to suppress the electrostatic force acting between the movable bodies 20a and 20b and the supports 30, 32, 34, and 36, and the substrate 10, by the electrodes 60. Accordingly, it is possible to prevent the movable bodies 20a and 20b from being stuck to the substrate 10.

It is possible to manufacture the physical quantity sensor 100 by the steps described above.

### 1.3. Modification Examples

Next, physical quantity sensors according to Modification Examples of the embodiment will be described with reference to the drawings. Regarding physical quantity sensors 200, 300, and 400 according to Modification Examples described below, the same reference numerals are used for the members having the same functions as the constituent elements of the physical quantity sensor 100 described above, and the description thereof will be omitted.

### 1. First Modification Example

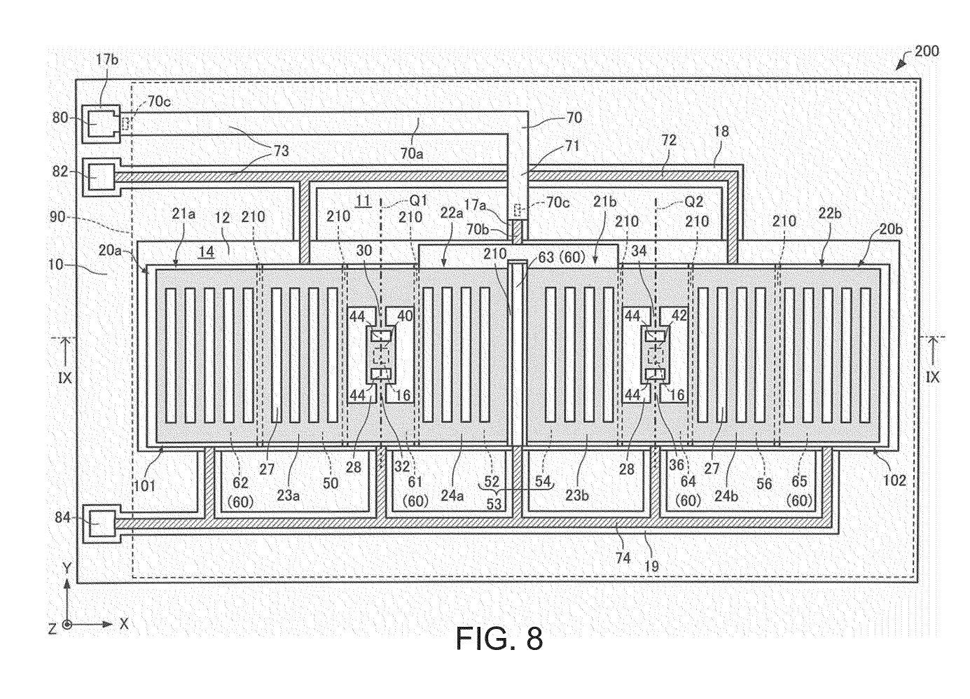

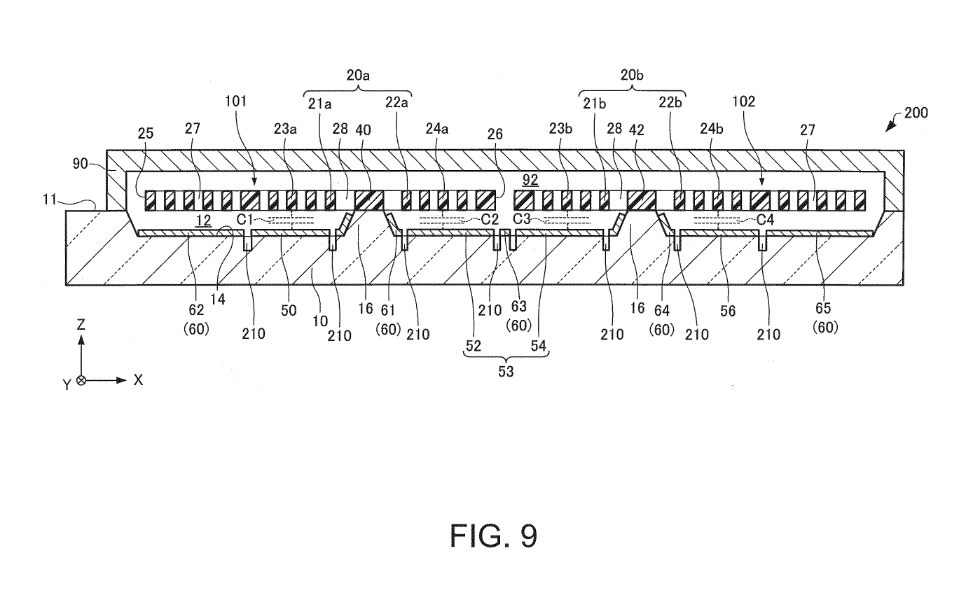

First, First Modification Example will be described. FIG. 8 is a plan view schematically showing the physical quantity sensor 200 according to First Modification Example. FIG. 9 is a cross-sectional view taken along line IX-IX of FIG. 8 and schematically showing the physical quantity sensor 200 according to First Modification Example. For convenience, the cover 90 is shown to be transparent in FIG. 8. In addition, in FIGS. 8 and 9 and FIGS. 10 to 13 which will be described below, the X axis, the Y axis, and the Z axis are shown as three axes which are orthogonal with respect to each other.

As shown in FIG. 8 and FIG. 9, in the physical quantity sensor 200, a groove portion 210 is formed on the substrate 10.

A plurality of the groove portions 210 are formed. The groove portions 210 are formed, in the substrate 10, in the area between the first fixed electrode portion 50 and the electrodes 60 adjacent to the first fixed electrode portion 50, the area between the second fixed electrode portion 52 and the electrodes 60 adjacent to the second fixed electrode portion 52, the area between the third fixed electrode portion 54 and the electrodes 60 adjacent to the third fixed electrode portion 54, and the area between the fourth fixed electrode portion 56 and the electrodes 60 adjacent to the fourth fixed electrode portion 56.

In detail, the groove portions 210 are formed, in the substrate 10, in the area between the first fixed electrode portion 50 and the electrodes 61 and 62 of the substrate 10, the area between the second fixed electrode portion 52 and the electrodes 61 and 63, the area between the third fixed electrode portion 54 and the electrodes 63 and 64, and the area between the fourth fixed electrode portion 56 and the electrodes 64 and 65. That is, in the physical quantity sensor 200, the groove portions 210 are provided on the substrate 10 between the electrodes 60 and the fixed electrode portions 50, 52, 54, and 56 adjacent thereto.

The groove portions 210 are formed on the bottom surface 14 of the recess 12. The groove portions 210 include a bottom surface (surface opposing the first movable body 20a or the second movable body 20b) having a greater distance between the groove portions and the first movable body 20a or the second movable body 20b, than that of the bottom surface 14 of the recess 12. By forming the groove portions 210, it is possible to increase the distance (distance in the Z axis direction) between the substrate 10 and the movable bodies 20a and 20b. Herein, the magnitude of the electrostatic force is inversely proportional to the square of the distance. Accordingly, by forming the groove portion 210, it is possible to suppress the electrostatic force acting between the substrate 10 and the movable bodies 20a and 20b.

The depth of the groove portions 210 is not particularly limited, as long as it is a depth at which the substrate 10 and the movable bodies 20a and 20b are not stuck to each other by the electrostatic force.

In the physical quantity sensor 200, it is possible to suppress the electrostatic force acting between the movable bodies 20a and 20b and the supports 30, 32, 34, and 36, and the substrate 10 by the groove portions 210, and to further reliably prevent the movable bodies 20a and 20b from being stuck to the substrate 10.

A manufacturing method of the physical quantity sensor 200 is the same as the manufacturing method of the physical quantity sensor 100 described above, except for adding a step of forming the groove portions 210 on the bottom surface 14 of the recess 12 by etching, and therefore the description thereof will be omitted.

### 2. Second Modification Example

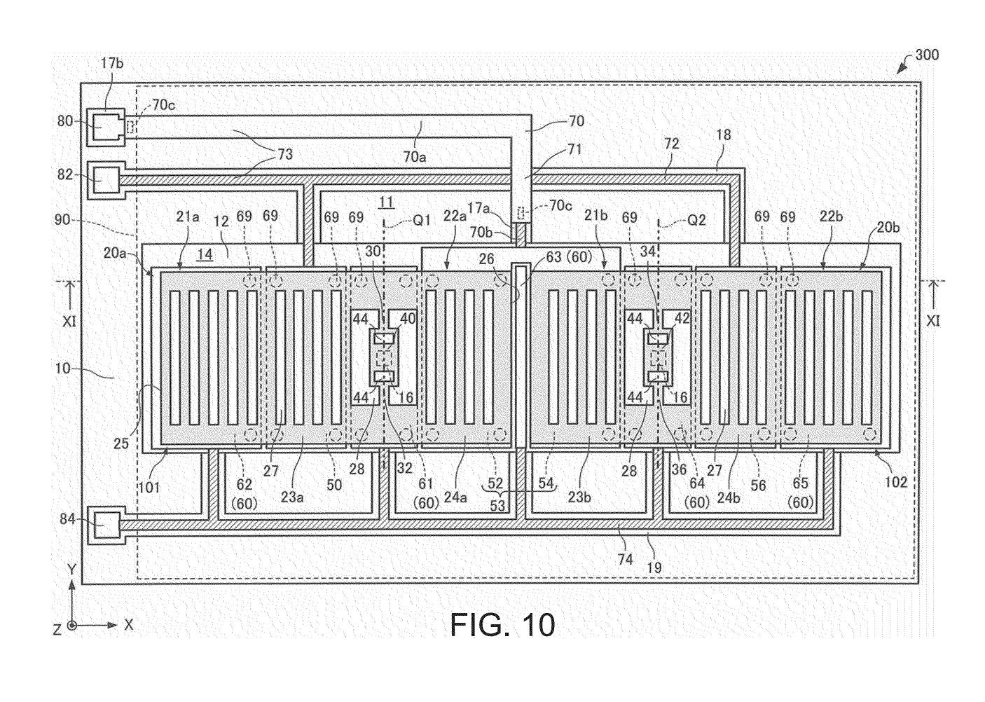

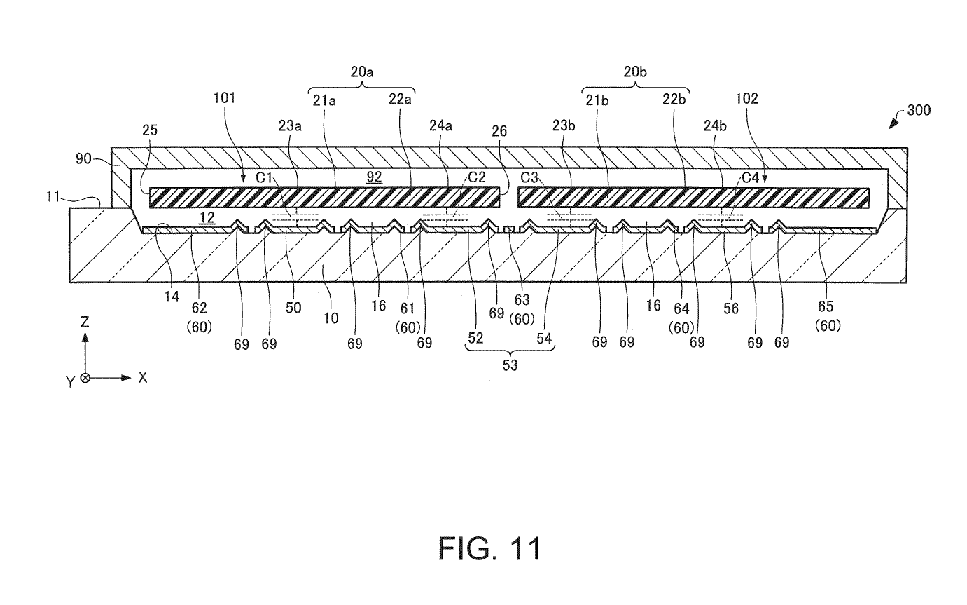

Next, Second Modification Example will be described. FIG. 10 is a plan view schematically showing the physical quantity sensor 300 according to Second Modification Example. FIG. 11 is a cross-sectional view taken along line XI-XI of FIG. 10 and schematically showing the physical quantity sensor 300 according to Second Modification Example. For convenience, the cover 90 is shown to be transparent in FIG. 10.

As shown in FIG. 10 and FIG. 11, in the physical quantity sensor 300, protrusion portions 69 are provided on the fixed electrode portions 50, 52, 54, and 56 and the electrodes 60.

The protrusion portions 69 are protruded toward the upper portion (to the side of the first movable body 20a or the second movable body 20b) from the fixed electrode portions 50, 52, 54, and 56 and the electrodes 60. A shape of the protrusion portions 69 is a spindle shape, for example. The protrusion portions 69 are provided in the area overlapped with the first movable body 20a or the second movable body 20b, in a plan view. The number or the positions of the protrusion portions 69 are not particularly limited. In the example shown in the drawing, the protrusion portions 69 are provided on both sides of an exposed area of the bottom surface 14 (area where the fixed electrode portions 50, 52, 54, and 56 and the electrodes 60 are not provided). In detail, the protrusion portions 69 are provided on four corners of the fixed electrode portions 50, 52, 54, and 56, four corners of the electrodes 61 and 64, end portions of the electrode 62 on the first fixed electrode portion 50 side, and end portions of the electrode 65 on the fourth fixed electrode portion 56 side.

In the physical quantity sensor 300, the protrusion portions 69 are provided on the fixed electrode portions 50, 52, 54, and 56 and the electrodes 60. Accordingly, it is possible to prevent the movable bodies 20a and 20b from being stuck to the substrate 10.

A manufacturing method of the physical quantity sensor 300 is the same as the manufacturing method of the physical quantity sensor 100 described above, except for etching so as to form protrusions on the bottom surface 14 when forming the recess 12, and forming conductive layers to be the fixed electrode portions 50, 52, 54, and 56 and the electrodes 60 on the protrusions to form the protrusion portions 69, and therefore the description thereof will be omitted.

### 3. Third Modification Example

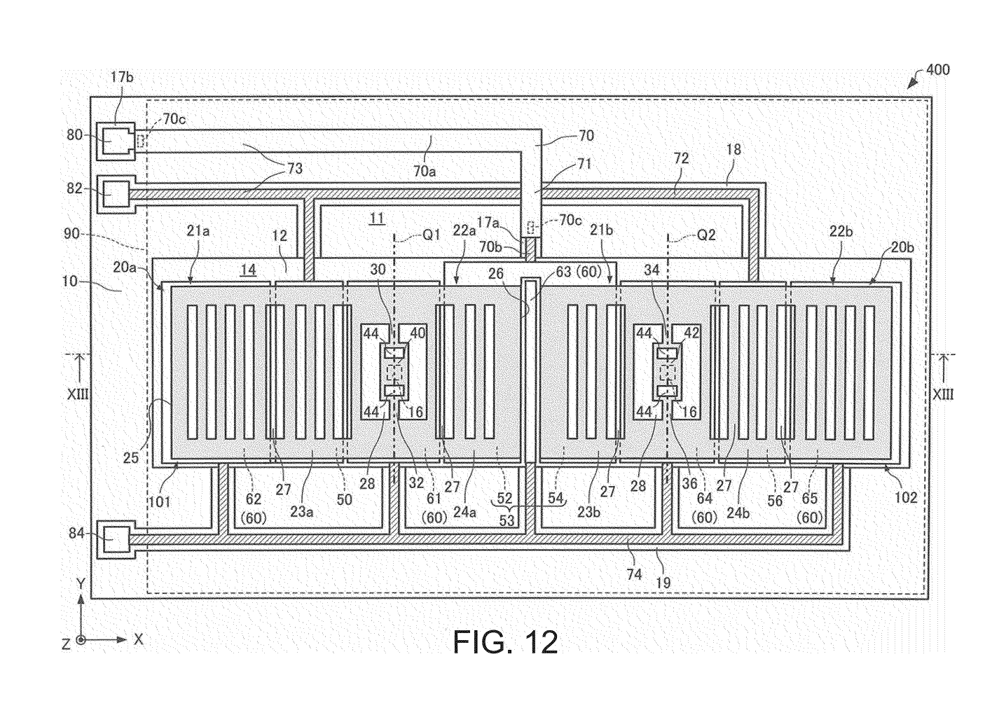

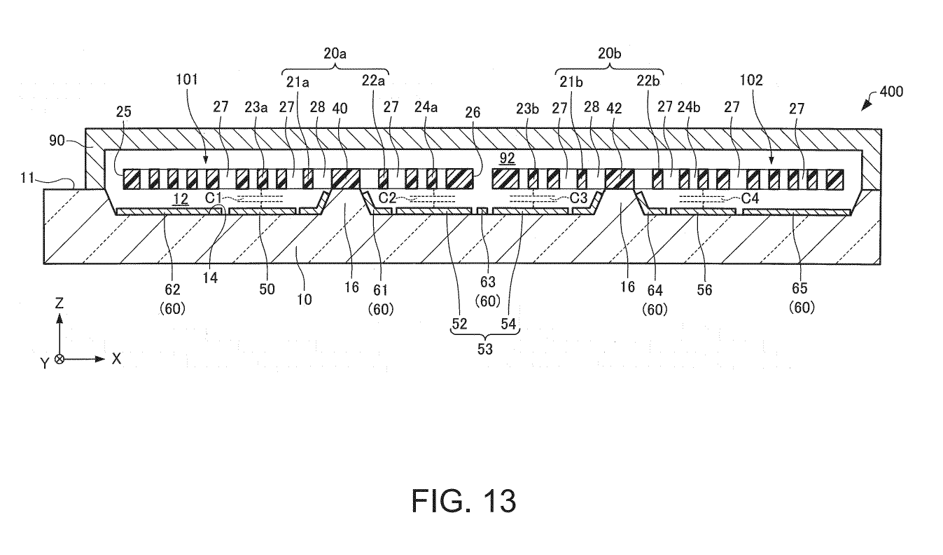

Next, Third Modification Example will be described. FIG. 12 is a plan view schematically showing the physical quantity sensor 400 according to Third Modification Example. FIG. 13 is a cross-sectional view taken along line XIII-XIII of FIG. 12 and schematically showing the physical quantity sensor 400 according to Third Modification Example. For convenience, the cover 90 is shown to be transparent in FIG. 12.

As shown in FIG. 12 and FIG. 13, in the physical quantity sensor 400, the slit portion 27 opposing the area between the first fixed electrode portion 50 and the electrodes 61 and 62 of the substrate 10, is formed on the first movable body 20a. In addition, the slit portion 27 opposing the area between the second fixed electrode portion 52 and the first electrode 61, is formed on the first movable body 20a.

The slit portion 27 opposing the area between the third fixed electrode portion 54 and the fourth electrodes 64 of the substrate 10, is formed on the second movable body 20b. In addition, the slit portion 27 opposing the area between the fourth fixed electrode portion 56 and the electrodes 64 and 65, is formed on the second movable body 20b.

In the physical quantity sensor 400, the slit portions 27 opposing the exposed area of the bottom surface 14 are formed. Accordingly, it is possible to suppress the electrostatic force acting between the movable bodies 20a and 20b and the substrate 10, and to prevent the movable bodies 20a and 20b from being stuck to the substrate 10.

### 4. Fourth Modification Example

Next, Fourth Modification Example will be described. Although not shown, a physical quantity sensor according to Fourth Modification Example is configured to include the groove portions 210 shown in FIG. 8 and FIG. 9, the protrusion portions 69 shown in FIG. 10 and FIG. 11, and the slit portions 27 shown in FIG. 12 and FIG. 13. Accordingly, it is possible to further reliably prevent the movable bodies 20a and 20b from being stuck to the substrate 10.

### 4. Electronic Device

Next, an electronic device according to the embodiment will be described with reference to the drawings. The electronic device according to the embodiment includes the physical quantity sensor according to the invention. Hereinafter, an electronic device including the physical quantity sensor 100 as the physical quantity sensor according to the invention will be described.

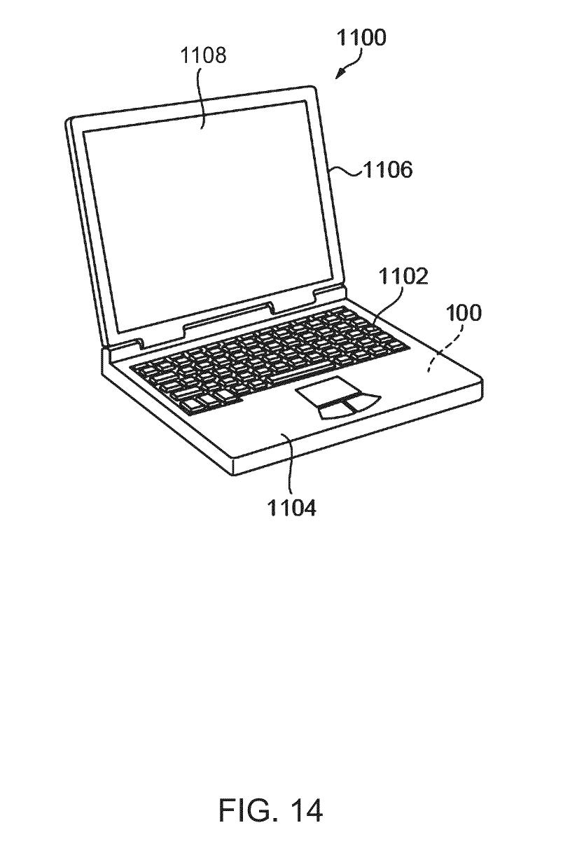

FIG. 14 is a perspective view schematically showing a mobile type (or note type) personal computer 1100 as the electronic device according to the embodiment.

As shown in FIG. 14, the personal computer 1100 is configured with a main body unit 1104 including a keyboard 1102 and a display unit 1106 including a display unit 1108, and the display unit 1106 is rotatably supported with respect to the main body unit 1104 through a hinge structure portion.

The physical quantity sensor 100 is embedded in such a personal computer 1100.

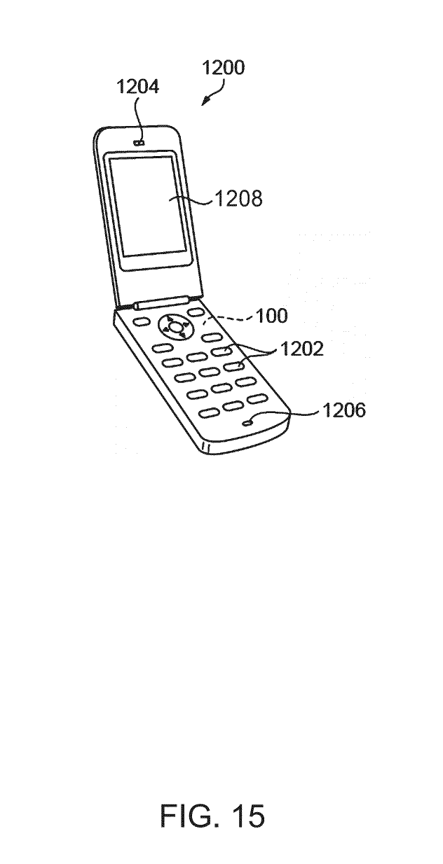

FIG. 15 is a perspective view schematically showing a mobile phone (including a PHS) 1200 as the electronic device according to the embodiment.

As shown in FIG. 15, the mobile phone 1200 includes a plurality of operation buttons 1202, an earpiece 1204, and a mouthpiece 1206, and a display unit 1208 is disposed between the operation buttons 1202 and the earpiece 1204.

The physical quantity sensor 100 is embedded in such a mobile phone 1200.

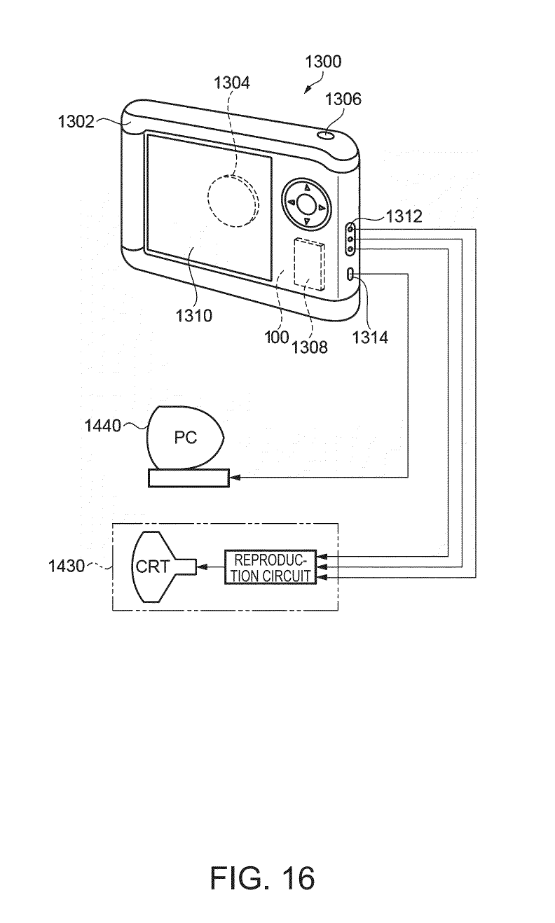

FIG. 16 is a perspective view schematically showing a digital still camera 1300 as the electronic device according to the embodiment. FIG. 16 also simply shows connection to an external device.

Herein, the digital still camera 1300 generates an imaging signal (image signal) by performing photoelectric conversion of a light image of a subject by an imaging device such as charge coupled device (CCD), whereas a normal camera exposes a silver-halide photo film by using a light image of a subject.

A display unit 1310 is provided on a rear surface of a case (body) 1302 of the digital still camera 1300 and has a configuration for performing a display based on the imaging signal by the CCD, and the display unit 1310 functions as a finder for displaying a subject as an electronic image.

A light receiving unit 1304 including an optical lens (optical imaging system) or the CCD is provided on a front surface side of the case 1302 (back surface side in the drawing).

When a photographer confirms a subject image displayed on the display unit 1310 and presses a shutter button 1306, an imaging signal of CCD at that time point is transmitted and stored in a memory 1308.

In the digital still camera 1300, a video signal output terminal 1312 and a data communication input and output terminal 1314 are provided on a side surface of the case 1302. A television monitor 1430 is connected to the video signal output terminal 1312 and a personal computer 1440 is connected to the data communication input and output terminal 1314, respectively if necessary. In addition, the imaging signal stored in the memory 1308 is output to the television monitor 1430 or the personal computer 1440 by a predetermined operation.

The physical quantity sensor 100 is embedded in the digital still camera 1300.

Since the electronic devices 1100, 1200, and 1300 include the physical quantity sensor 100, the miniaturization thereof can be realized.

In addition to the personal computer (mobile type personal computer) shown in FIG. 14, the mobile phone shown in FIG. 15, and the digital still camera shown in FIG. 16, the electronic device including the physical quantity sensor 100 can be applied to an ink jet type discharging apparatus (for example, ink jet printer), a laptop type personal computer, a television, a video camera, a video camera recorder, various navigation apparatuses, a pager, an electronic organizer (including those having communication function), an electronic dictionary, a calculator, an electronic game device, a head mount display, a word processer, a work station, a video phone, a security monitor, electronic binoculars, a POS terminal, medical equipment (for example, an electronic thermometer, a blood pressure meter, a blood glucose meter, an ECG measuring device, a ultrasound diagnostic device, an electronic endoscope), a fish finder, a variety of measurement equipments, a meter (for example, a meter for vehicles, aircraft, a rocket, or a ship), attitude control of a robot or a human body, a flight simulator, or the like.

### 5. Moving Object

Next, a moving object according to the embodiment will be described with reference to the drawings. The moving object according to the embodiment includes the physical quantity sensor according to the invention. Hereinafter, a moving object including the physical quantity sensor 100 as the physical quantity sensor according to the invention will be described.

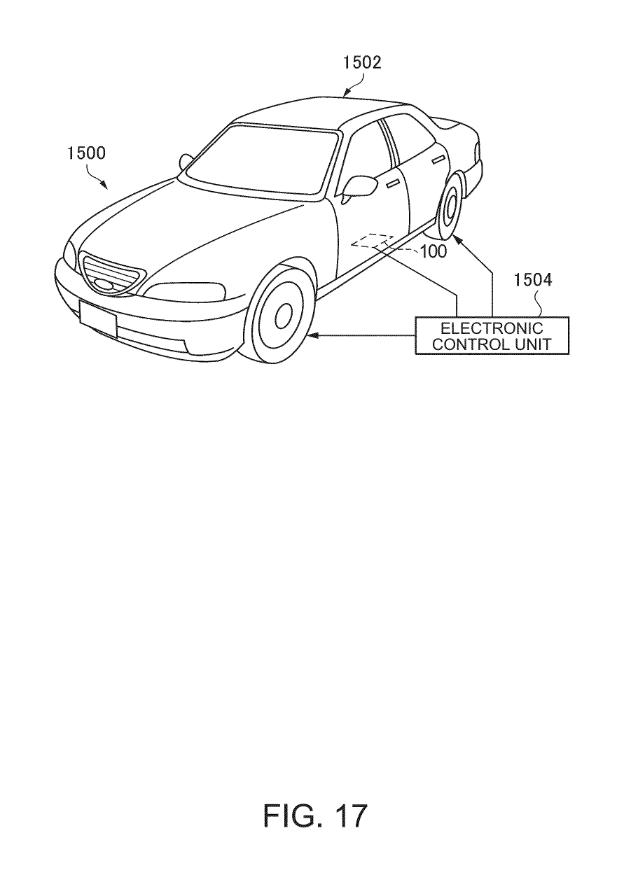

FIG. 17 is a perspective view schematically showing a vehicle 1500 as the moving object according to the embodiment.

The physical quantity sensor 100 is embedded in the vehicle 1500. In detail, as shown in FIG. 17, an electronic control unit (ECU) 1504 in which the physical quantity sensor 100 for sensing the acceleration of the vehicle 1500 to control output of an engine, is mounted on a body 1502 of the vehicle 1500. The physical quantity sensor 100 can also be widely applied to a vehicle body attitude control unit, an anti-lock brake system (ABS), an airbag, and a tire pressure monitoring system (TPMS).

Since the vehicle 1500 includes the physical quantity sensor 100, the miniaturization thereof can be realized.

The embodiment and Modification Examples are merely examples and the invention is not limited thereto. For example, the embodiment and Modification Examples can be appropriately combined with each other.

The invention includes substantially the same configuration as the configuration described in the embodiment (for example, a configuration having the same functions, methods, and results, or a configuration having the same object and effects). The invention includes a configuration obtained by replacing the non-essential parts of the configuration described in the embodiment. The invention includes a configuration for realizing the same operation results or a configuration for reaching the same object as the configuration described in the embodiment. The invention includes a configuration obtained by adding the related art to the configuration described in the embodiment.

What is claimed is:

1. A physical quantity sensor comprising:
a substrate;
a first movable body which is disposed on the substrate, can be displaced around a first support shaft, and includes a first movable electrode portion;
a second movable body which is disposed on the substrate, can be displaced around a second support shaft, and includes a second movable electrode portion; and
a fixed electrode portion which is overlapped on the first movable electrode portion and the second movable electrode portion and is disposed on the substrate in a plan view.

2. The physical quantity sensor according to claim 1,
wherein, when the first movable body is divided into a first portion and a second portion with the first support shaft as a boundary, the physical quantity sensor further includes
a first fixed electrode portion which is disposed on the substrate to oppose the first portion, and
a second fixed electrode portion which is disposed on the substrate to oppose the second portion, and
wherein, when the second movable body is divided into a third portion and a fourth portion with the second support shaft as a boundary, the physical quantity sensor further includes
a third fixed electrode portion which is disposed on the substrate to oppose the third portion and is electrically connected to the second fixed electrode portion, and
a fourth fixed electrode portion which is disposed on the substrate to oppose the fourth portion.

3. The physical quantity sensor according to claim 2,
wherein the second fixed electrode portion and the third fixed electrode portion are connected to a first pad by a first wire, and
wherein the first fixed electrode portion and the fourth fixed electrode portion are connected to a second pad by a second wire.

4. The physical quantity sensor according to claim 3, further comprising:
a signal processing circuit,
wherein the signal processing circuit calculates a difference between an output signal of the first pad and an output signal of the second pad.

5. The physical quantity sensor according to claim 2,
wherein the first fixed electrode portion, the second fixed electrode portion, the third fixed electrode portion, and the fourth fixed electrode portion are provided on the same substrate.

6. The physical quantity sensor according to claim 5,
wherein an electrode is disposed in at least one of an area between the first fixed electrode portion and the second fixed electrode portion, an area between the second fixed electrode portion and the third fixed electrode portion, and an area between the third fixed electrode portion and the fourth fixed electrode portion, on the substrate.

7. The physical quantity sensor according to claim 6,
wherein the electrode disposed between the first fixed electrode portion and the second fixed electrode portion is electrically connected to the first movable body.

8. The physical quantity sensor according to claim 6,
wherein the electrode disposed between the second fixed electrode portion and the third fixed electrode portion is electrically connected to at least one of the first movable body and the second movable body.

9. The physical quantity sensor according to claim 6,
wherein the electrode disposed between the third fixed electrode portion and the fourth fixed electrode portion is electrically connected to the second movable body.

10. The physical quantity sensor according to claim 6,
wherein the electrodes are disposed on both sides of respective first fixed electrode portion, the second fixed electrode portion, the third fixed electrode portion, and the fourth fixed electrode portion.

11. The physical quantity sensor according to claim 6,
wherein groove portions are provided on the substrate between the electrodes and the fixed electrode portions adjacent thereto.

12. An electronic device comprising the physical quantity sensor according to claim 1.

13. A moving object comprising the physical quantity sensor according to claim 1.
